(19) United States
(12) Patent Application Publication
(10) Pub. No.: US 2020/0045582 A1
(43) Pub. Date: Feb. 6, 2020

(54) METHOD AND APPARATUS FOR TRANSFERRING AGGREGATED PACKETS

(71) Applicant: Nokia Technologies Oy, Espoo (FI)

(72) Inventors: Samuli Heikki Turtinen, Ii (FI); Chunli Wu, Beijing (CN); Esa Mikael Malkamäki, Espoo (FI); Benoist Pierre Sebire, Tokyo (JP)

(21) Appl. No.: 16/605,573

(22) PCT Filed: Apr. 23, 2018
(86) PCT No.: PCT/IB2018/052815

§ 371 Date: Oct. 16, 2019

Related U.S. Application Data
(60) Provisional application No. 62/502,293, filed on May 5, 2017.

(51) Int. Cl. H04W 28/06; H04L 29/06; H04L 29/08; H04W 80/02

(52) U.S. Cl. CPC H04W 28/065; H04W 80/02; H04L 67/2828; H04L 69/22

(57) ABSTRACT

In accordance with an example embodiment of the present invention, there is disclosed apparatus, method sand storage mediums with computer-readable instructions for transmitting aggregated packets, comprising dividing a plurality of data units into ordered groups and advantageously encoding sub-headers for the data units to be aggregated. In accordance with an example embodiment of the present invention, there is disclosed apparatus, method sand storage mediums with computer-readable instructions for receiving the aggregated packets with the advantageously encoding sub-headers.

### CROSS REFERENCE TO RELATED APPLICATION

This application claims the benefit of U.S. provisional application No. 62/502,293 entitled “Method and apparatus for transferring aggregated packets” filed on May 5, 2017, which is incorporated herein by reference in its entirety.

### TECHNICAL FIELD

The present application relates generally to efficient aggregation of data packets potentially belonging to different logical channels for transmission.

### BACKGROUND

In LTE as defined in 3GPP TS 36.321 v14.2.1, a medium access control (MAC) layer is provided which allows for aggregation of MAC service data units (SDUs) into a single MAC protocol data unit (PDU). This is accomplished by adding in the header of a MAC PDU for each SDU a sub-header in accordance with FIG. 1. A bit F2 in the header indicates whether the following two octets contain a length field of 16 bits. If F2 is not set, then bit F indicates whether a length field of 7 or 15 bits follows. An E bit indicates whether it is the last header in the MAC PDU. The logical channel identifier (LCID) indicates the logical channel the MAC SDU belongs to or indicates a type of MAC control element (CE). Bits indicated as R are presentedly reserved for future use. Header 104 is only used as first or last sub-header to indicate optional padding or when MAC SDUs are configured to all have indentical length, in which case indicating the MAC SDU length is superfluous. Each sub-header in a MAC PDU is as such independent of other sub-headers in the MAC PDU header and self-contained.

### SUMMARY

Various aspects of examples of the invention are set out in the claims.

According to a first aspect of the present invention, there is disclosed an apparatus, method and storage medum with computer-readable instructions for dividing a a plurality of data units into ordered groups in accordance with both of a identifier associated with a respective data unit and a sub-header characteristic associatable with the respective data unit; configuring a sub-header for each first data unit in each group to comprise the sub-header characteristic associatable with the respective first data unit and to comprise an indication of the identifier associated with the respective first data unit; configuring a sub-header for each non-first data unit in each group to not comprise the identifier of the respective non-first data unit and to not comprise the sub-header characteristic associatable with the respective non-first data unit; prepend each data unit in each group with its respective sub-header; and transmitting the grouped data units with their respective prepended sub-header in a packet data unit.

According to a second aspect of the present invention, there is disclosed an apparatus, method and storage medum with computer-readable instructions for receiving a concatenation of grouped data units each prepended with a respective sub-header; determining from the sub-header of a first data unit of the grouped data units an identifier, a sub-header characteristic and an indication whether the first data unit is the last data unit in a group; associating the identifier and the sub-header characteristic with each subsequent data unit of the grouped data units for which the sub-header of the data unit immediately preceding the respective subsequent data unit is indicative of not being the last data unit in the group; extracting each data unit in accordance with the sub-header of the respective data unit, the sub-header interpreted in accordance with the associated sub-header characteristic; and transferring the extracted data units to a higher layer using the associated identifiers.

### BRIEF DESCRIPTION OF THE DRAWINGS

For a more complete understanding of example embodiments of the present invention, reference is now made to the following descriptions taken in connection with the accompanying drawings in which:

FIG. 1 illustrates MAC PDU sub-headers in accordance with the LTE standard;

FIG. 2 illustrates a MAC PDU structure in accordance with embodiments of invention; and

FIG. 3 illustrates a flow diagram for receiving grouped SDUs in accordance with embodiments of the invention; and

FIG. 4 illustrates a flow diagram for transmitting grouped SDUs in accordance with embodiments of the invention; and

FIG. 5 illustrates a block diagram illustrating an example wireless apparatus in accordance with embodiments of the invention.

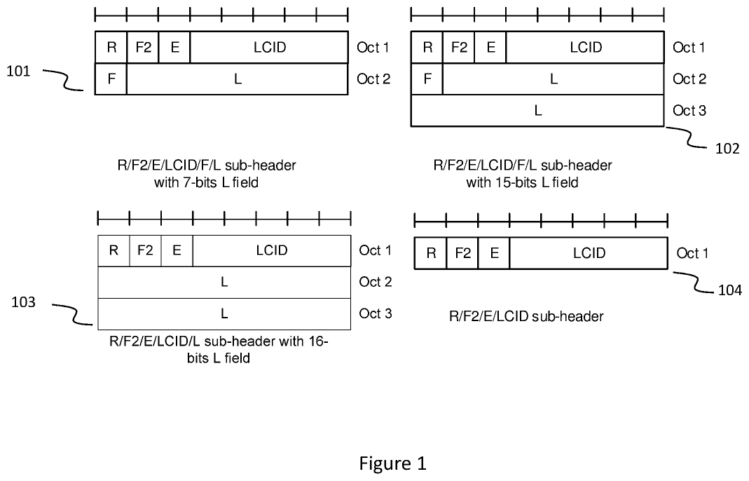

### DETAILED DESCRIPTION

In 5G New Radio, the MAC layer is likely to receive many SDUs belonging to the same logical channel which could be aggregated into a single MAC PDUs. Because many SDUs are relatively short, an approach whereby each SDU would cause a full sub-header to be added similar to LTE would imply significant sub-header overhead. In accordance with embodiments of the present invention, the overhead is substantially reduced by grouping SDUs in accordance with their logical channel and length field size.

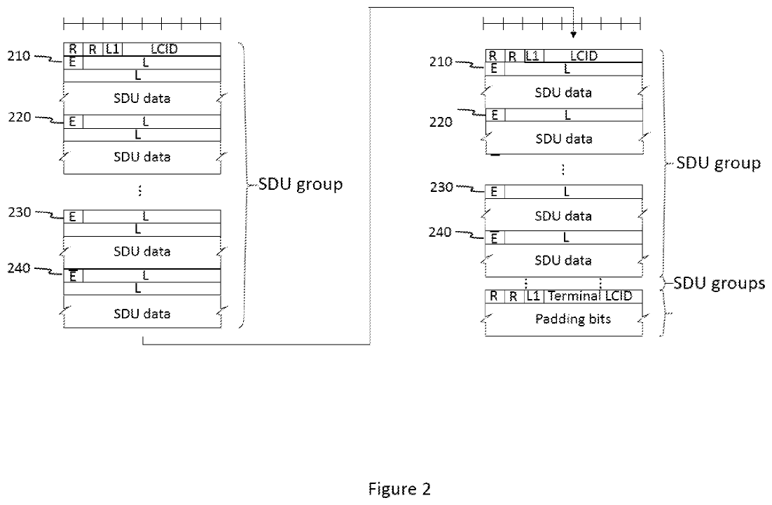

FIG. 2 shows a MAC PDU structure in accordance with embodiments of the invention. In contrast to LTE, sub-headers are interspersed with the SDUs, such that each SDU is immediately preceded by its corresponding sub-header. One skilled in the art will naturally appreciate that the sub-headers may also be consolidated into a MAC header without departing from the scope of the invention. The depicted MAC PDU is depicted to comprise a plurality of groups of SDUs where for the first and second group only the first (210), second (220), one-but-last (230) and last (240) SDU and corresponding subheaders are explicitly shown. It should naturally be understood that the number of groups in a MAC PDU may vary, but will in pertinence to the present invention be at least one. Similarly, the number of SDUs aggregated in a group may vary, but will be at least one.

Indication L1 is provided to indicate the size of a length field in the sub-header, for example whether the size is 7 or 15 bits. If more than two sizes are available, more than one bit may be required, for example using one of the bits presently indicated as reserved (R). The LCID indicates the logical channel the MAC SDU(s) belongs to. An LCID may also indicate a type of MAC CE, which is generally not associated with an SDU and as such not shown in FIG. 2. Where it is depicted that an LCID comprises 5 bits, one skilled in the art will appreciate that it may comprise more bits, for example by reducing the number of reserved bits R to one.

Indication E indicates whether an SDU associated with the subheader is the last SDU in a group. As such, all but the last sub-header of a group indicate not to be the last and only the last sub-header (240) in a group indicates to be the last for a group. Furthermore, in each of the sub-headers except the first sub-header in each group, the octet comprising the length size indication L1 and LCID is omitted, reducing the overhead caused by the second and subsequent sub-headers in each group as they are presumed configured with the same LCID and same L field size as the first one in the group. In an alternative embodiment, the number of SDUs in a group may be fixed, indicated in a first sub-header of the group, indicated in a MAC header or otherwise conveyed.

The groups are followed as shown by a terminal LCID, indicating that no further groups of SDUs are following. The terminal LCID might be comprised in a sub-header such as a padding sub-header comprising a padding LCID or any other sub-header not indicative of being followed by an SDU. Alternatively, the terminal LCID maybe comprised in any MAC CE, the LCID of which equally indicating that no further groups of SDUs are following. In yet another embodiment, the terminal subheader or MAC CE may be omitted if a total size of the MAC PDU is provided, e.g. at the start of the MAC PDU or from a lower layer (for example based on transport block size (TBS)), from which it may be determined that no further groups are following. In a further alternative, the total number of groups in the MAC PDU may be indicated. In a yet further alternative, the total number of groups per logical channel in the MAC PDU may be indicated.

In some embodiments, an indication may be provided before transmission of the MAC PDU or at the start of the MAC PDU that all length fields have the same size. In some embodiments, this indication may be provided before, or in the first sub-header of, each SDU group to indicate that the length fields of this group have the same size as in the previous group. Naturally this is not limited to all MAC SDUs being carried having the same size, merely that their length is carried is in a same size length field. In this case, the length size indication L1 may be ignored or may be overwritten with the indication E, indicating whether the SDU is the last SDU in a group. The length field may then be extended to include the presently indicated E field, such that it extends to one more octets, such as 8 or 16 bits. While this approach increases the overhead of sub-headers, any MAC PDU carrying an SDU requiring a 16 bit length field would comprise so much SDU data that the sub-header overhead would be comparatively negligible.

In some embodiments, indicating a 16 bit length field in a first sub-header for a SDU will always result in the SDU being followed by a first sub-header for the next SDU or SDU group. E.g., the indication of a 16 bit length field may be indicative of the SDU being both the first and last SDU in the group.

In some embodiments, it is semi-statically configured for a logical channel to always use 16 bits length field size without indication of the length in the MAC sub-header, or regardless of the length field size indication in the sub-header.

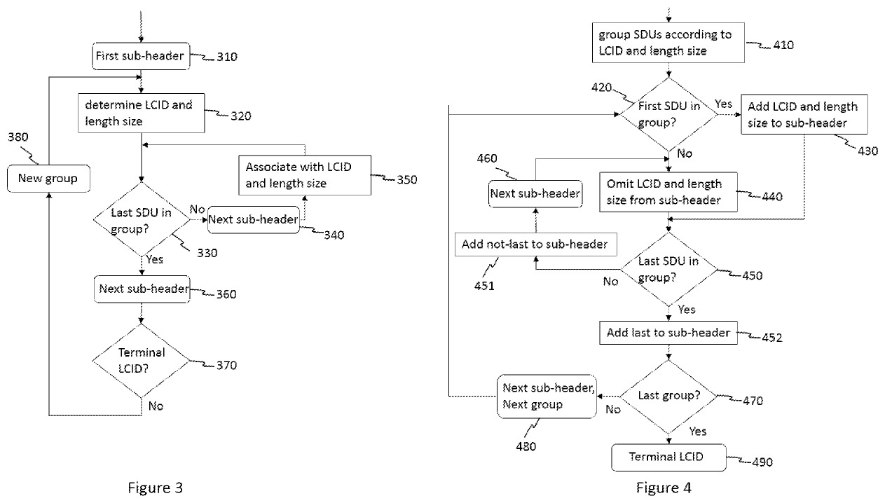

FIG. 3 depicts a flow diagram for receiving grouped SDUs in accordance with embodiments of the invention. At 310, a first sub-header in the MAC PDU is decoded. As the first sub-header is also a first sub-header in a first group, the first sub-header comprises an LCID and a size of a length indication of a first SDU following the sub-header. The LCID and size of the length indication are determined at 320. In addition, it is determined at 330 from the first sub-header whether it is also the last SDU sub-header in the first group. If not the last SDU-header, the process moves on to the next sub-header at 341, now known to belong to the same group. While not depicted for brevity, generally the SDU associated with the sub-header and of a length indicated in the length field with the indicated length size, is extracted and stored for transfer to a higher layer. Because the next sub-header is known to belong to same group and therefor does not contain an LCID or length size, the LCID and length size determined at 320 are associated with this next sub-header and the next sub-header and corresponding MAC SDU are processed accordingly. Returning to to 330, also for this next sub-header it is checked whether it is the last SDU sub-header in the first group. Extraction of sub-headers and SDUs is hence repeated in accordance with 340, 350 and 330 until a sub-header indicates to be the last sub-header in the first group.

When a sub-header indicates at 330 to be the last sub-header in a group, the next sub-header is checked at 360, unless it is known from side-information such as a MAC PDU length or a known number of groups in the MAC PDU that no further groups are comprised in the MAC PDU. When such side-information is not available, it is checked at 370 whether the next sub-header is indicative of a terminal LCID or a MAC CE LCID. If so, then the process of extracting MAC SDUs terminates at 370. If not, then the next sub-header is indicative of another MAC SDU belonging to a new group as depicted at 380 and the processing of this new group initiates again at 320.

FIG. 4 depicts a flow diagram for transmitting grouped SDUs in accordance with embodiments of the invention. At 410, a set of SDUs is grouped in accordance with the logical channel the respective SDUs belong to and the size of the length field appropriate for the respective SDUs. Such a grouping may take various forms. For example, grouping may be performed by checking whether subsequently incoming or subsequently stored SDUs whether they can be grouped together in accordance with their respective LCIDs and length field sizes. Such a form would result in a grouping in accordance with an existing order, possibly resulting in non-sequential groups having the same LCID and length field size. In a more elaborate form, grouping may be performed by identifying from a set of MAC SDUs to be transmitted in a MAC PDU all MAC SDUs having a same LCID and length field size, resulting in all groups having a unique combination of LCID and length field size. In a yet more elaborate form, the LCID and/or length field size of an SDU may determine whether the SDU is transmitted in a given MAC PDU, such that a preference is given to SDUs that can be grouped together over SDUs that would require an additional group. One skilled in the art will further appreciate that while the grouping is depicted at the start of the process, further grouping may occur at time during the depicted process. For example, while constructing a group for a MAC PDU, a set of urgent SDUs may arrive, for which a new group in the MAC PDU may be added or an existing group may be expanded.

In any case, after at least some grouping has been executed, a first SDU is identified at 420 for a first group. Because it is the first SDU, it is prepended with a sub-header comprising its corresponding LCID and length field size. Additionally it checked at 450 whether the first SDU is also the last SDU in the group.

If it is not the last SDU in the group, then it is indicated at 451 in the sub-header that is not the last SDU in the group. While not shown for brevity, the sub-header is then completed and associated with the SDU. The process then moves to 460 where the next sub-header for the next SDU is initiated. Because this next SDU is not the first SDU in the group, the LCID and length size are at 440 omitted from the next sub-header, reducing the overhead caused by this next subheader. Again it is checked whether this next sub-header is the last SDU sub-header in the group, where if this is not the case, the process repeats through 451, 460 and 440 until the sub-header being constructed is the last SDU sub-header for the group, at which point the process moves to 452 where it is indicated in the sub-header being constructed that it is the last sub-header in the group. While not shown for brevity, the sub-header being constructed is then completed and associated with the SDU.

Having finalized a group at 452, it is then checked at 470 whether a further group is to be added to the MAC PDU. If so, a new first sub-header is initiated for the new group and process of constructing the group continues from 420. If no further groups are to be added, and assuming no side-information is provided to allow a receiver to determine which group is a last group, a sub-header, such as a padding sub-header, or MAC CE is added such that its LCID is indicative of no further SDU groups being present in the MAC PDU. Naturally multiple sub-headers or MAC CEs may be added without restriction in accordance with their respective function, but a first one suffices as terminal LCID indication.

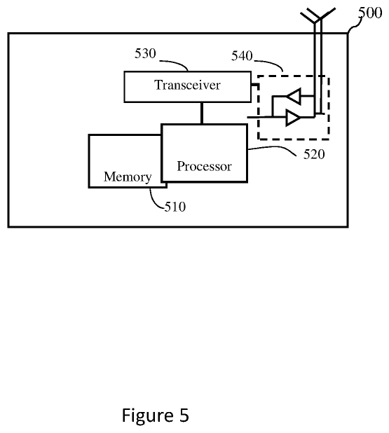

FIG. 5 depicts a block diagram illustrating an example wireless apparatus (500) in accordance with embodiments of the invention. The wireless apparatus may include at least one processor (520), at least one memory (810) coupled to the at least one processor (520) and at least one suitable transceiver (530) having a transmitter and a receiver coupled to the at least one processor (520), coupled to at least one antenna unit (850) through at least one amplifier (540). The at least one memory (510) may store computer programs, which may, when executed by the at least one processor (820), for example in combination with any of the at least one transceiver (530), at least one amplifier (540) and at least one antenna unit (550), perform embodiments of the invention. For example an infrastructure node or user equipment may be embodied in apparatus 500.

Embodiments of the invention may be implemented in software (executed by one or more processors), hardware (e.g., an application specific integrated circuit or field programmable gate array), or a combination of software and hardware. In an example embodiment, the software (e.g., application logic, an instruction set) is maintained on any one of various conventional non-transitory computer-readable media.

Although various aspects are set out above, other aspects comprise other combinations of features from the described embodiments, and not solely the combinations described above.

While the invention has been generally described within the context of aggregating MAC SDUs, it should be appreciated that the invention may be applied at any other layer of any communication interface, where the local channel identifier may be replaced with any other data unit classification identifier and the length field size may be replaced with another characteristic.

It is also noted herein that while the above describes example embodiments of the invention, these descriptions should not be viewed in a limiting sense. Rather, there are several variations and modifications which may be made without departing from the scope of the present invention as defined in the appended claims.

1. An apparatus, comprising:
at least one processor; and
at least one memory including computer program code
the at least one memory and the computer program code configured to, with the at least one processor, cause the apparatus to perform at least the following:
divide a plurality of data units into ordered groups in accordance with both of an identifier associated with a respective data unit and a sub-header characteristic associatable with the respective data unit;
configure a sub-header for each first data unit in each group to comprise the sub-header characteristic associatable with the respective first data unit and to comprise an indication of the identifier associated with the respective first data unit;
configure a sub-header for each non-first data unit in each group to not comprise the identifier of the respective non-first data unit and to not comprise the sub-header characteristic associatable with the respective non-first data unit;
prepend each data unit in each group with its respective sub-header; and
transmit the grouped data units with their respective prepended sub-header in a packet data unit.

2. The apparatus of claim 1, the at least one memory and the computer program code further configured to, with the at least one processor, cause the apparatus to perform at least the following:
configure the sub-header of each terminal data unit in each group to comprise an indication that the respective terminal data unit is the last data unit in the respective group; and
configure the sub-header of each non-terminal data unit in each group to comprise an indication that the respective non-terminal data unit is not the last data unit in the respective group.

3. The apparatus of claim 1, the at least one memory and the computer program code further configured to, with the at least one processor, cause the apparatus to perform at least the following:
insert after a given group in the packet data unit at least one sub-header or control element comprising an identifier indicative of not being associated with a data unit, such that the identifier is further indicative of the given group being the last group in the packet data unit.

4. The apparatus of claim 3, wherein the given group is a last group comprising at least one service data unit in a packet data unit.

5. The apparatus of claim 1, wherein the identifier is a local channel identifier.

6. The apparatus of claim 1, wherein the sub-header characteristic associatable with the respective data unit is a size of a length field for indicating a length of the respective data unit.

7. The apparatus of claim 6, wherein the size of the length field being 16 bits indicates that the respective data unit is the last data unit in a group.

8. The apparatus of claim 1, wherein the apparatus comprises a user equipment or an access node.

9. An apparatus, comprising:
at least one processor; and
at least one memory including computer program code
the at least one memory and the computer program code configured to, with the at least one processor, cause the apparatus to perform at least the following:
receive a concatenation of grouped data units each prepended with a respective sub-header.
determine from the sub-header of a first data unit of the grouped data units an identifier, a sub-header characteristic and an indication whether the first data unit is the last data unit in a group;
associate the identifier and the sub-header characteristic with each subsequent data unit of the grouped data units for which the sub-header of the data unit immediately preceding the respective subsequent data unit is indicative of not being the last data unit in the group;
extract each data unit in accordance with the sub-header of the respective data unit, the sub-header interpreted in accordance with the associated sub-header characteristic; and
transfer the extracted data units to a higher layer using the associated identifier.

10. The apparatus of claim 9, the at least one memory and the computer program code further configured to, with the at least one processor, cause the apparatus to perform at least the following:
verify from a sub-header or control element following a data unit of the grouped data units which sub-header indicates that the data unit is a last data unit in a group whether the sub-header or control element indicates an identifier not associated with a data unit; and
if the sub-header or control element following the data unit of the grouped data units which sub-header indicates that the data unit is a last data unit in a group, does not indicate the identifier not associated with a data unit, repeat the determining, associating and verifying for at least one data unit of the grouped data units associated with a further group.

11. (canceled)

12. The apparatus of claim 9, wherein the sub-header characteristic associatable with the respective data unit is a size of a length field for indicating a length of the data unit.

13. The apparatus of claim 12, wherein extracting each data unit in accordance with the sub-header of the respective data unit comprises determining a length of the respective data unit from the sub-header using the size of the length field.

14. The apparatus of claim 12, wherein the size of the length field being 16 bits indicates that the respective data unit is the last data unit in a group.

15. The apparatus of claim 9, wherein the apparatus comprises a user equipment or an access node.

16. A method comprising
dividing a plurality of data units into ordered groups in accordance with both of an identifier associated with a respective data unit and a sub-header characteristic associatable with the respective data unit;
configuring a sub-header for each first data unit in each group to comprise the sub-header characteristic associatable with the respective first data unit and to comprise an indication of the identifier associated with the respective first data unit;
configuring a sub-header for each non-first data unit in each group to not comprise the identifier of the respective non-first data unit and to not comprise the sub-header characteristic associatable with the respective non-first data unit;
prepending each data unit in each group with its respective sub-header; and
transmitting the grouped data units with their respective prepended sub-header in a packet data unit.

17. The method of claim 16, further comprising:
configuring the sub-header of each terminal data unit in each group to comprise an indication that the respective terminal data unit is the last data unit in the respective group; and
configuring the sub-header of each non-terminal data unit in each group to comprise an indication that the respective non-terminal data unit is not the last data unit in the respective group.

18. The method of claim 16, further comprising:
inserting after a given group in the packet data unit at least one sub-header or control element comprising an identifier indicative of not being associated with a data unit, such that the identifier is further indicative of the given group being the last group in the packet data unit.

19. The method of claim 18, wherein the given group is a last group comprising at least one service data unit in a packet data unit.

20. (canceled)

21. The method of claim 16, wherein the sub-header characteristic associatable with the respective data unit is a size of a length field for indicating a length of the respective data unit.

22. The method of claim 21, wherein the size of the length field being 16 bits indicates that the respective data unit is the last data unit in a group.

23-30. (canceled)
